(19) United States
(12) Patent Application Publication
(10) Pub. No.: US 2008/0307529 A1
(43) Pub. Date: Dec. 11, 2008

(54) Method and Apparatus for Protecting Internet Privacy

(75) Inventors: Dae Seon Choi, Daejeon-city (KR); Seung Hun Jin, Daejeon-city (KR)

Correspondence Address: LAHIVE & COCKFIELD, LLP;FLOOR 30, SUITE 3000, ONE POST OFFICE SQUARE, BOSTON, MA, 02109, US

(73) Assignee: Electronics & Telecommunications Research Institute, Daejeon (KR)

(21) Appl. No.: 12/096,835

(22) PCT Filed: Jun. 2, 2006
(86) PCT No.: PCT/KR06/02123

§ 371 Date: Jun. 10, 2008

(30) Foreign Application Priority Data
Dec. 10, 2005 (KR) 10-2005-0121239

(51) Int. Cl. H04L 9/00

(52) U.S. Cl. 726/26

(57) ABSTRACT

A method of protecting personal information on the Internet, and an apparatus thereof are provided. The method includes: sensing transmission through the Internet of personal information of a user; detecting information on a website that is the destination of the sensed transmission of the personal information; comparing information on the detected website with a personal information protection policy; and permitting or blocking the transmission of the personal information according to the comparison result. According to the method, in order to minimize leakage of personal information from a website, when user information is input to the website, providing of the personal information is controlled based on information on whether or not the website is reliable in terms of personal information protection such that providing of the personal information to a dangerous website can be prevented, and possible damage by leakage of personal information can be prevented in advance. Also, in order to prevent phishing, that is, obtaining user's personal information through a fake website having an appearance similar to a famous website, the method helps the user identify a fake website such that possibility of phishing can be minimized.

### TECHNICAL FIELD

The present invention relates to information security, and more particularly, to a method and apparatus for protecting personal information on the Internet.

### BACKGROUND ART

Leakage of personal information on the Internet and resultant damages have become a very serious problem. Leakage of personal information leakage includes leakage of personal information input to an Internet website, phishing, that is, obtaining user's personal information through a fake website similar to a well-known website, intercepting personal information using a malicious program, such as a spyware, installed in the personal computer (PC) of a user, and network sniping between a user and a website.

Personal identification information may include the name and address of a user, a resident registration number, a credit card number, a password, and the like.

Among the technologies developed so far to prevent personal information leakage, the leading one is an encryption technology that prevents interception of user information on a network. However, many users do not have this technology.

Meanwhile, a technology for detecting and deleting spyware installed in a PC of a user has been developed. However, the main purpose of this technology is not to protect leakage of personal information, and the technology must be upgraded continuously to deal with new spyware continuously appearing.

### DISCLOSURE OF INVENTION

### Technical Problem

The present invention provides a method and apparatus for protecting personal information on the Internet.

### Technical Solution

According to an aspect of the present invention, there is provided a method of protecting personal information on the Internet, the method including: sensing transmission through the Internet of personal information of a user; detecting information on a website that is the destination site of the sensed transmission of the personal information; comparing information on the detected website with a personal information protection policy; and permitting or blocking the transmission of the personal information according to the comparison result.

According to another aspect of the present invention, there is provided an apparatus for protecting personal information on the Internet, the apparatus including: a transmission sensing unit sensing transmission of personal information of a user through the Internet; a destination information detection unit detecting information on a website that is the destination site of the sensed transmission of the personal information; and a providing-of-personal-information determination unit comparing the detected information on the website with a predetermined personal information protection policy database, and permitting or blocking the transmission of the personal information according to the comparison result.

### ADVANTAGEOUS EFFECTS

According to the present invention, in order to minimize leakage of personal information from a website, when user information is input to the website, providing of the personal information is controlled based on information on whether or not the website is reliable in terms of personal information protection such that providing of the personal information to a dangerous website can be prevented, and possible damage by leakage of personal information can be avoided. Also, in order to prevent phishing, the present invention helps a user identify a fake website such that possibility of phishing can be minimized.

### DESCRIPTION OF DRAWINGS

The above and other features and advantages of the present invention will become more apparent by describing in detail exemplary embodiments thereof with reference to the attached drawings in which:

FIG. 1 is a flowchart of a method of protecting personal information on the Internet according to an embodiment of the present invention;

FIG. 2 illustrates a structure of an apparatus for protecting personal information on the Internet according to an embodiment of the present invention; and

FIG. 3 illustrates an example of a structure of an apparatus for protecting personal information on the Internet according to an embodiment of the present invention, including an environment in which the apparatus is used.

### BEST MODE

According to an aspect of the present invention, there is provided a method of protecting personal information on the Internet, the method including: sensing transmission through the Internet of personal information of a user; detecting information on a website that is the destination site of the sensed transmission of the personal information; comparing information on the detected website with a personal information protection policy; and permitting or blocking the transmission of the personal information according to the comparison result.

According to another aspect of the present invention, there is provided an apparatus for protecting personal information on the Internet, the apparatus including: a transmission sensing unit sensing transmission of personal information of a user through the Internet; a destination information detection unit detecting information on a website that is the destination site of the sensed transmission of the personal information; and a providing-of-personal-information determination unit comparing the detected information on the website with a predetermined personal information protection policy database, and permitting or blocking the transmission of the personal information according to the comparison result.

The apparatus may further include a user query unit sending a query to the user and receiving an answer therefrom. The providing-of-personal-information determination unit may compare the detected information on the website with a predetermined reliability class of websites, and according to the predetermined personal information protection policy, by using a processing method according to the comparison result, may permit or block the transmission of the personal information, or may send a query to the user, and may permit or block the transmission of the personal information according to an answer of the user.

### Mode for Invention

The present invention will now be described more fully with reference to the accompanying drawings, in which exemplary embodiments of the invention are shown.

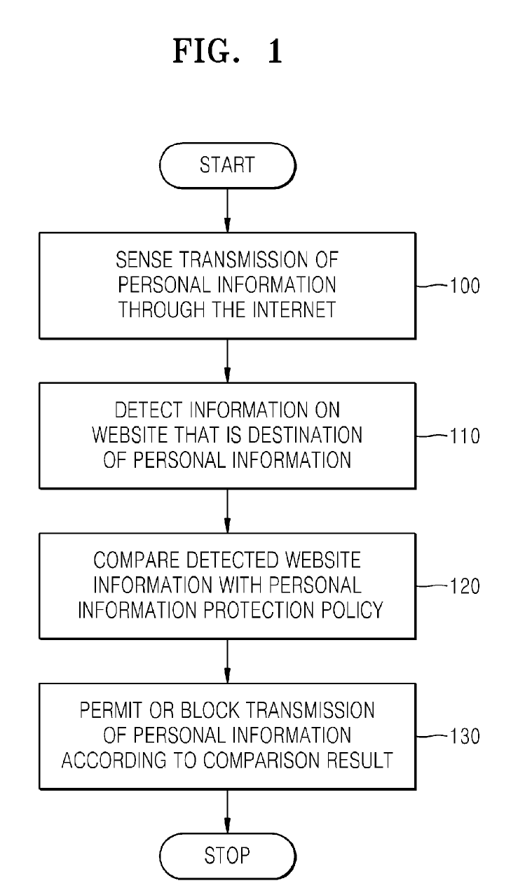

FIG. 1 is a flowchart of a method of protecting personal information on the Internet according to an embodiment of the present invention.

Transmission of personal information of a user through the Internet is sensed in operation 100. Information on a website which is the destination site of the sensed transmission of the personal information is detected in operation 110. The detected information on the website is compared with a predetermined personal information protection policy in operation 120, and the transmission of the personal information is permitted or blocked according to the comparison result in operation 130.

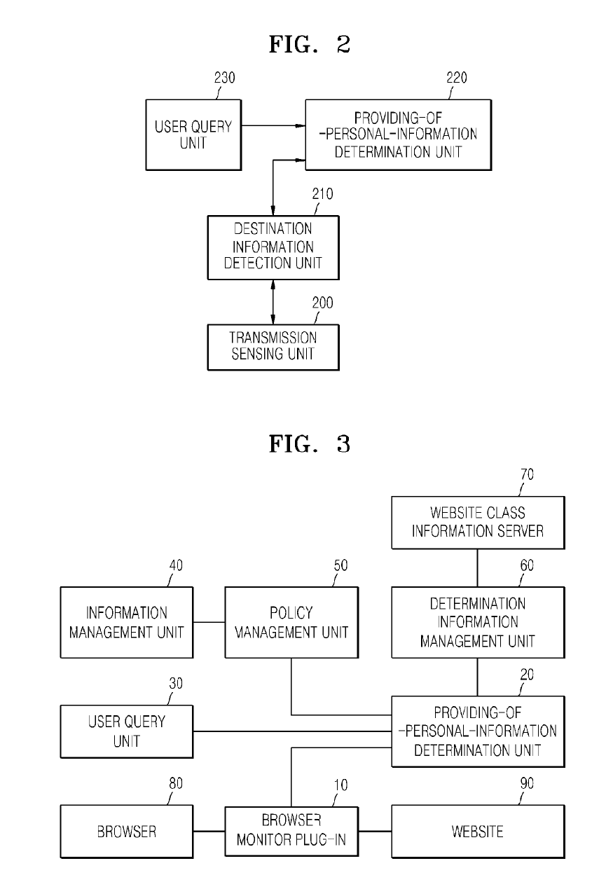

FIG. 2 illustrates a structure of an apparatus for protecting personal information on the Internet according to an embodiment of the present invention.

The apparatus of FIG. 2 includes a transmission sensing unit 200 sensing transmission of personal information of a user through the Internet, a destination information detection unit 210 detecting information on a website that is the destination site of the sensed transmission of the personal information, and a providing-of-personal-information determination unit 220 comparing the detected information on the website with a predetermined personal information protection policy database, and permitting or blocking the transmission of the personal information according to the comparison result.

The apparatus of FIG. 2 also includes a user query unit 230 sending a query to the user and receiving a reply therefrom. If the information on the website that is the destination site of the transmission of the personal information is detected, the providing-of-personal-information determination unit 220 compares the detected information on the website with a predetermined reliability class of websites,

Then, according to the predetermined personal information protection policy, by using a processing method according to the comparison result, the transmission of the personal information is permitted or blocked, or by sending a query to the user and receiving a replay therefrom, the transmission of the personal information is permitted or blocked according to the reply.

FIG. 3 illustrates an example of a structure of an apparatus for protecting personal information on the Internet according to an embodiment of the present invention, including an environment in which the apparatus is used. FIG. 3 illustrates the structure of the apparatus of FIG. 2, including the surrounding environment, and the flowchart and apparatus of FIGS. 1 and 2 will be explained in more detail through explanation of FIG. 3.

A plug-in monitor browser 10 analyzes information input by a user through a browser 80 in order to be transmitted to a website 90, senses personal information, and when necessary, blocks the transmission of the personal information. The plug-in monitor browser 10 is a program which begins to operate if the browser program of a computer begins to operate. As will be explained later, the plug-in monitor browser 10 performs the functions of the transmission sensing unit 200 and the destination information detection unit 210.

The plug-in monitor browser 10 analyzes the information transmitted from the browser 80 to the website 90, and if the information includes personal information, sends a query to the providing-of-personal-information determination unit 20 on whether or not the information can be transmitted to the website 90. Then, when the transmission is permitted, the plug-in monitor browser monitor 10 transmits the information, and if the transmission is prohibited, the plug-in monitor browser monitor 10 does not transmit the information.

As a method of sensing personal information by the plug-in monitor browser 10, a method of comparing a name part of an hypertext transfer protocol (http) parameter with a personal information item pattern is used.

For example, in an http transmission,

http://www.sitename.com/cgi-bin/user-regist?name=kimcheolsoo& addr=seoulcitydongjakgu . . . ,

the http parameter name ‘name’ is compared with a personal information item pattern kept by the plug-in monitor browser 10. At this time, the http parameter value is also examined so that only items having actual values are compared.

The providing-of-personal-information determination unit 20 receives the query from the plug-in monitor browser 10, and determines whether or not the personal information can be transmitted to the website.

If the plug-in monitor browser 10 sends a query on whether or not to permit the personal information, the query including the contents of the item of the personal information and the name of the receiving website, the providing-of-personal-information determination unit 20 sends a query on the personal information protection reliability class of the receiving website to a determination information management unit 60, and receives a result therefrom.

The determination information management unit 60 sends a lowest class as an answer if the receiving website cannot be found.

In case of phishing, that is, obtaining user, personal information through a fake website similar to a well-known website, a user may consider the fake website as being the well-known website. However, when the providing-of-personal-information determination unit 20 searches a personal information protection reliability class list, for the website to which the information is to be transmitted, it is highly probable that the website cannot be found by a normal method.

The personal information protection reliability class of an identified website indicates the degree that the website performs appropriately protection of collected personal information, and according to this class, whether or not to transmit personal information can be determined. For example, it may be determined that transmission of personal information to a website having a low personal information protection reliability class is not permitted.

Whether or not to transmit which personal information according to which class is determined according to a personal information transmission permission policy obtained from a policy management unit 50.

A personal information providing policy has predetermined personal information items, and one value among permission, prohibition, and user query with respect to a predetermined personal information protection reliability class.

Among these, the user query refers to sending a query to the user through the user query unit 30.

The user query unit 30 is a user interface to send a query to the user as to whether or not to permit transmission of personal information.

The providing-of-personal information determination unit 20 sends to the user the personal information protection reliability class of the website that receives the personal information, and sends a query as to whether or not to continue transmission of the personal information. As a response to the query, the user may select to continue or stop the process. If the user sends an answer to continue the process, the providing-of-personal-information unit 20 determines that the response indicates permission of providing information, and allows the information to be transmitted.

An information management unit 40 is a user interface to input and manage information that is stored and managed in a policy management unit 50. Through the information management unit 40, the user can input and modify a personal information transmission permission policy that is stored in the policy management unit 50. As a result, the policy management unit 50 stores the personal information transmission permission policy that is input and managed through the information management unit 40.

A determination information management unit 60 stores a personal information protection reliability class list of websites, and when the providing-of-personal-information determination unit 20 inquires the personal information protection reliability class of a predetermined website, the determination information management unit 60 responds to this.

If the providing-of-personal-information determination unit 20 does not have information on a requested specific website, the providing-of-personal-information determination unit 20 sends a lowest class as an answer.

The personal information protection reliability class list of websites can be obtained from a website class information server 70. In this case, when a program of the determination information management unit 60 starts operating, the personal information protection reliability class list of the website is downloaded from the website class information server 70.

The website class information server 70 stores and manages the personal information protection reliability class list of websites, and when there is a request from the determination information management unit 60, permits download of the personal information protection reliability class list of the website.

The personal information protection reliability class list of websites is input by an administrator of the website class information server 70, and a class for a website can be assigned based on data provided by a management organization for protection of personal information and notoriety to the public. The website class information server 70 is a single server on the Internet, unlike other elements of FIG. 3 that are installed in the PC of the user.

The operation of the apparatus or system for protecting personal information on the Internet according to an embodiment of the present invention will now be explained.

The user sets a transmission permission policy through the information management unit 40, and the set personal information permission policy is stored in the policy management unit 50.

When the apparatus for protecting personal information on the Internet starts operating, the determination information management unit 60 accesses the website class information server 70, and downloads the personal information protection reliability class list of the website.

If the user inputs personal information through the browser 80 and transmits the personal information to the website 90, the plug-in monitor browser 10 senses the transmission of the user's personal information in operation 100, and detects information on the website 90 in operation 110. Since information on the website 90 is included in the header of the packet being transmitted, the information on the website 90 is detected in the header part of the packet input by the user.

The plug-in monitor browser 10 sends a query to the providing-of-personal-information determination unit 20 as to whether or not to permit that transmission of the personal information. In the query, the name of the website 90 that should receive the personal information and the personal information items being transmitted are included.

The providing-of-personal-information determination unit 20 obtains the personal transmission permission policy of the user from the policy management unit 50, and inquires the determination information management unit 60 of the personal information protection reliability class of the website 90 included in the query.

In this process, the information on the website 90 is compared with the personal information protection policy in operation 120.

The providing-of-personal-information determination unit 20 compares the queried personal information item with the personal information protection reliability class of the website 90. If permission is granted in response to the comparison result according to the personal information transmission permission policy, the providing-of-personal-information determination unit 20 sends a permission answer to the plug-in monitor browser 10 in operation 130. After the plug-in monitor browser 10 receives the answer, it transmits the personal information to the website 90.

If permission is not granted according to the personal information transmission permission policy, the providing-of-personal-information determination unit 20 sends a prohibition answer to the plug-in monitor browser 10 in operation 130.

The browser monitor plug-in 10 cancels the transmission of the personal information, and the user is informed through the browser 80 that the transmission of the personal information is canceled because the personal information protection reliability class of the website is low.

If the personal information transmission permission policy indicates a user query, the providing-of-personal-information determination unit 20 displays the personal information protection reliability class of the website 90 receiving the personal information, through the user query unit 30, and asks the user whether or not to continue the transmission of the personal information. If the user chooses to continue the transmission, the providing-of-personal-information determination unit 20 sends a permission answer to the plug-in monitor browser 10 in operation 130. If the user chooses to stop the transmission 30, the providing-of-personal-information determination unit 20 sends a prohibition answer to the plug-in monitor browser 10 so that the transmission of the personal information is blocked in operation 130.

A method to help a user identify whether or not a website is a fake website in order to prevent phishing will now be explained.

When the personal information protection reliability class of the reception website is inquired for in operation 120, it is highly probable that information on the fake website does not exist in the website class information server 70. Accordingly, the fake website is classified as the lowest personal information protection reliability class.

It is probable that the personal information protection permission policy of the user for a website having the lowest personal information protection reliability class is set to prohibition or user query. Accordingly, a user query or cancellation of the transmission is performed.

A famous website has a high personal information protection reliability class. Accordingly, if the user receives a prohibition answer for personal information transmission or a query for the site that the user thinks to be a famous site, the user begins to suspect that the website is not a real site, but a fake website. Thus, the user can identify the site as being a fake website.

The above explanation is about preventing transmission of information input by the user to a phishing website. However, the present invention is not limited to this.

For example, when the user does not intend to transmit any information, that is, when personal information of the user is leaked even without the user's input of the information, if the leakage of the personal information is sensed according to the present invention, the leakage may be blocked or the user may be informed that the transmission of the information can be permitted or blocked according to the his/her determination.

According to the present invention, in order to minimize leakage of personal information from a website, when user information is input to the website, providing of the personal information is controlled based on information on whether or not the website is reliable in terms of personal information protection such that providing of the personal information to a dangerous website can be prevented, and possible damage by leakage of personal information can be avoided. Also, in order to prevent phishing, the present invention helps a user identify a fake website such that possibility of phishing can be minimized.

While the present invention has been particularly shown and described with reference to exemplary embodiments thereof, it will be understood by those of ordinary skill in the art that various changes in form and details may be made therein without departing from the spirit and scope of the present invention as defined by the following claims. The preferred embodiments should be considered in descriptive sense only and not for purposes of limitation. For example, though the Internet is explained as an example of a communication network in the above description, the embodiment can also be used in a public telephone communication network, such as a public switched telephone network (PSTN).

Therefore, the scope of the invention is defined not by the detailed description of the invention but by the appended claims, and all differences within the scope will be construed as being included in the present invention.

Also, it is easily understood by those skilled in the art that each step of the present invention can be implemented in a variety of ways, including by software using a general programming technique, and by hardware.

Partial operations of the present invention can also be embodied as computer readable codes on a computer readable recording medium. The computer readable recording medium is any data storage device that can store data which can be thereafter read by a computer system.

### INDUSTRIAL APPLICABILITY

The present invention can be used in the field of information security, and in the field of protecting personal information on the Internet, in particular.

1. A method of protecting personal information on the Internet, the method comprising:
sensing transmission through the Internet of personal information of a user;
detecting information on a website that is the destination site of the sensed transmission of the personal information;
comparing information on the detected website with a personal information protection policy; and
permitting or blocking the transmission of the personal information according to the comparison result.

2. The method of claim 1, wherein the sensing of the transmission of the personal information is performed according to whether or not actual data is set in a name part of an http (hypertext transfer protocol) parameter of an http transmission protocol.

3. The method of claim 1, wherein in the comparing of the information on the detected website with the personal information protection policy, the detected information on the website is compared with a predetermined reliability class of websites, and according to the predetermined personal information protection policy, by using a processing method according to the comparison result, the transmission of the personal information is permitted or blocked, or a query is sent to the user, and according to an answer to the query, the transmission of the personal information is permitted or blocked.

4. An apparatus for protecting personal information on the Internet, the apparatus comprising:
a transmission sensing unit sensing transmission of personal information of a user through the Internet;
a destination information detection unit detecting information on a website that is the destination site of the sensed transmission of the personal information; and
a providing-of-personal-information determination unit comparing the detected information on the website with a predetermined personal information protection policy database, and permitting or blocking the transmission of the personal information according to the comparison result.

5. The apparatus of claim 4, wherein the transmission sensing unit senses the transmission of the personal information according to whether or not actual data is set in a name part of an http parameter of an http transmission protocol.

6. The apparatus of claim 4, further comprising a user query unit sending a query to the user and receiving an answer therefrom,
wherein the providing-of-personal-information determination unit compares the detected information on the website with a predetermined reliability class of websites, and according to the predetermined personal information protection policy, by using a processing method according to the comparison result, permits or blocks the transmission of the personal information, or a query is sent to the user, and the transmission of the personal information is permitted or blocked according to an answer to the query.
